(19) United States
(12) Patent Application Publication
(10) Pub. No.: US 2014/0136644 A1
(43) Pub. Date: May 15, 2014

(54) DATA STORAGE MANAGEMENT IN COMMUNICATIONS

(71) Applicants: Janne Einari Tuononen, Nummela (FI); Ville Petteri Poyhonen, Espoo (FI); Ove Bjorn Strandberg, Lappböle (FI)

(72) Inventors: Janne Einari Tuononen, Nummela (FI); Ville Petteri Poyhonen, Espoo (FI); Ove Bjorn Strandberg, Lappböle (FI)

(73) Assignee: NOKIA SOLUTIONS AND NETWORKS OY, Espoo (FI)

(21) Appl. No.: 14/130,131

(22) PCT Filed: Jul. 1, 2011
(86) PCT No.: PCT/EP2011/061085

§ 371 Date: Dec. 30, 2013

(51) Int. Cl. H04L 29/08

(52) U.S. Cl. CPC H04L 67/2842
USPC 709/213

(57) ABSTRACT

A method for caching data is disclosed, in which a network apparatus (401) partitions (600) the data into chunks to be stored in at least one priority cache and in at least one secondary cache. In response to receiving (602), in the network apparatus (401) a content request message (601) related to a user terminal (403), the apparatus checks (602) whether prioritized chunks of the requested content are available in a priority cache, the apparatus transmits (603) the prioritized chunks of the content from the priority cache to the user terminal (403). The apparatus (401) also retrieves non-prioritized chunks of the content to the priority cache from a secondary cache, wherein the retrieved non-prioritized chunks are transmitted (605) to the user terminal (403).

### FIELD OF THE INVENTION

The exemplary and non-limiting embodiments of this invention relate generally to wireless communications networks, and more particularly to caching data.

### BACKGROUND

The following description of background art may include insights, discoveries, understandings or disclosures, or associations together with disclosures not known to the relevant art prior to the present invention but provided by the invention. Some such contributions of the invention may be specifically pointed out below, whereas other such contributions of the invention will be apparent from their context.

Communications service providers provide users with access to a wide variety of content services via communications networks. A peer-to-peer technology enables a low cost and efficient distribution of content.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

Various aspects of the invention comprise a method, apparatus, and a computer-readable storage medium as defined in the independent claims. Further embodiments of the invention are disclosed in the dependent claims.

According to an aspect of the present invention, there is provided a method for caching data in a communications system, the method comprising partitioning the data into chunks to be stored in at least one priority cache and in at least one secondary cache; wherein, in response to receiving, in a network apparatus a content request message related to a user terminal, the method comprises checking whether at least a part of the requested content is available in the at least one priority cache; wherein if at least a part of the requested content is available in the at least one priority cache, the method comprises transmitting one or more prioritized chunks of the content to the user terminal, the prioritized chunks being stored in the at least one priority cache; wherein the method comprises retrieving non-prioritized chunks of the content to the at least one priority cache from the at least one secondary cache; and transmitting one or more of the retrieved non-prioritized chunks of the content to the user terminal.

According to another aspect of the present invention, there is provided an apparatus configured to partitioning data into chunks to be stored in at least one priority cache and in at least one secondary cache, wherein, in response to receiving a content request message related to a user terminal, the apparatus is configured to check whether at least a part of the requested content is available in the at least one priority cache; wherein if at least a part of the requested content is available in the at least one priority cache, the apparatus is configured to transmit one or more prioritized chunks of the content to the user terminal, the prioritized chunks being stored in the at least one priority cache; wherein the apparatus is configured to retrieve non-prioritized chunks of the content to the at least one priority cache from the at least one secondary cache; and transmit one or more of the retrieved non-prioritized chunks of the content to the user terminal.

According to yet another aspect of the present invention, there is provided a computer-readable storage medium embodying a program of instructions executable by a processor to perform actions directed toward partitioning data into chunks to be stored in at least one priority cache and in at least one secondary cache; checking, in response to receiving, in a network apparatus, a content request message related to a user terminal, whether at least a part of the requested content is available in the at least one priority cache; transmitting, if at least a part of the requested content is available in the at least one priority cache, one or more prioritized chunks of the content to the user terminal, the prioritized chunks being stored in the at least one priority cache; retrieving non-prioritized chunks of the content to the at least one priority cache from the at least one secondary cache; and transmitting one or more of the retrieved non-prioritized chunks of the content to the user terminal.

### BRIEF DESCRIPTION OF THE DRAWINGS

In the following the invention will be described in greater detail by means of preferred embodiments with reference to the attached drawings, in which

FIG. 1 illustrates data chunking according to an exemplary embodiment;

FIG. 2 illustrates data caching according to an exemplary embodiment;

FIG. 3 illustrates cache size according to an exemplary embodiment;

FIG. 4 shows a simplified block diagram illustrating an exemplary system architecture;

FIG. 5 shows a simplified block diagram illustrating exemplary apparatuses;

FIG. 6 shows a messaging diagram illustrating an exemplary messaging event according to an exemplary embodiment;

FIG. 7 shows a schematic diagram of a flow chart according to an exemplary embodiment.

### DETAILED DESCRIPTION OF THE INVENTION

Caching is a fundamental building block for ensuring scalability of various data solutions. Caching may be used both in control plane and in user plane. For instance, a global DNS (domain name system) relies heavily on caching and distribution to ensure scaling. Web proxies are another example of widely deployed cache solutions in the internet. It is also becoming evident that the data explosion that we are already witnessing today, will rise the importance of caching in the near future.

Peer-to-peer content sharing is another group of widely used applications in the internet. BitTorrent is probably the most well-known of them. A Torrent system establishes content sharing overlay where each end-node using a Torrent client may also become a source for the downloaded content. The system may be accessed through tracker nodes that manage content indexing within the Torrent. The more clients are connected, the more powerful and reliable content sharing gets established. A user may prohibit download from it to other nodes, but this is likely to diminish its own download service quality (or prohibit it). While the use of Torrents (especially in the dawn of their time) was many times linked to sharing of illegal content or content under copyright, nowadays they are used in lawful means. For example, a very popular massive multiplayer online role playing game, World of Warcraft, uses Torrent together with centralized (“seed”) content servers to share patch files among millions of players in a very short time (in a few hours' time window).

Efficient content delivery is a challenge in the networks, especially in internet-scale systems. BitTorrent (http://www.bittorrent.com/) and other types of peer-to-peer overlay technologies may be utilized, as well as different caching solutions varying from fully centralized (e.g. an on-path web proxy) to fully distributed (e.g. server farms used for caching). Spotify music service uses head-office servers for a fast response time when client downloads a music file. At a later stage, the file download at the client is moved to be done from the other participating Spotify clients in a peer-to-peer fashion. This, however, is Spotify-specific and not available for other use cases.

An exemplary embodiment provides a cost efficient scalable caching mechanism that makes content delivery in a communications network more efficient. An exemplary embodiment provides a data storage system with intelligent caching by using two level caching/storage approach; a fast response (priority cache) and a slower response (non-priority cache, also referred to as a secondary cache). This division is made to reduce overall costs of such a system since a default storage space in an expensive fast responsive system is kept at minimum time without the user experience suffering.

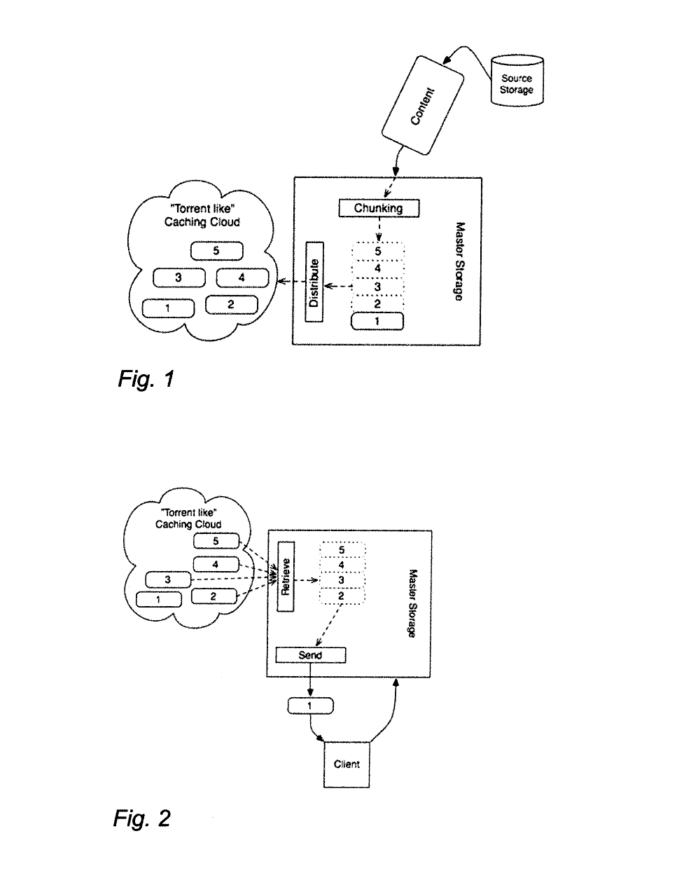

FIG. 1 illustrates chunking and relocating according to an exemplary embodiment.

FIG. 1 shows a data storage system which downloads the content and after this, storage management function enables chunking (if not already chunked) of the stored content. Once chunking is done, prioritized chunks (chunk 1) are kept available in a master storage (i.e. priority cache), and each chunk (non-prioritized and also a copy of prioritized chunks) is distributed temporarily into a Torrent like secondary level data storage system(s) (i.e. secondary caches). A definition of the prioritized chunks may vary depending on the content type, but typically they are chunks that are needed in a fast enabling of the service at the receiver end (for example, the first 30 seconds of a video). Similarly, non-prioritized chunks refer to data that is to be sent to the requestor after the prioritized chunks. For example, in the video case, the remaining chunks in the consumption order.

FIG. 2 illustrates a content request according to an exemplary embodiment. FIG. 2 shows basic content request use case according to an exemplary embodiment. When a data storage receives a data request for content, content sending may be started immediately from the prioritized chunks (chunk 1) and in parallel the storage management enables retrieving of the remaining chunks (chunks 2-5) from the secondary cache to the master storage (i.e. priority cache). This may be done in such a way that the priority cache each time has enough data to be sent to the requestor without interrupting the service (e.g. video streaming). After the request has been fully served and no pending request for the same content exists, the content may be kept in the priority cache for a short period of time (on hold for a possible new request). If no new request is received during that period, the non-prioritized content chunks may be removed from the priority cache. It should be noted that only copies of the chunks are typically retrieved to the priority cache, and the original chunks remain in the secondary cache.

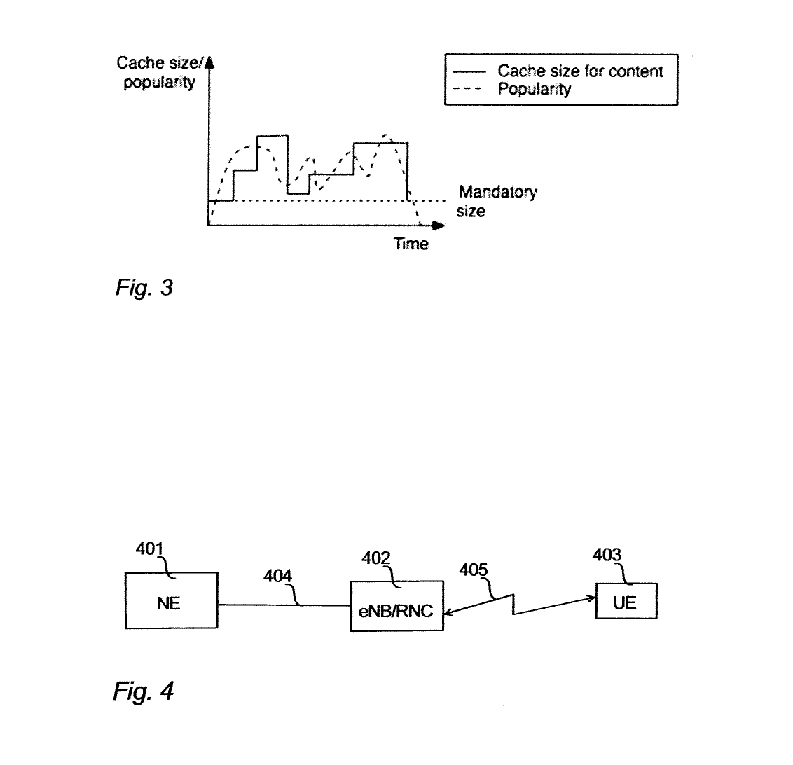

FIG. 3 illustrates dynamic cache size per content and popularity (a specific content may be considered popular if a lot requests are received for it (what “a lot” means may be definable by the operator or the apparatus)) according to an exemplary embodiment. Data importance represents another potential monitoring aspect alongside data popularity. There may be more important data and chunks that are considered important, for a user, to be received with a lower delay than other data/chunks. The number of chunks to be held in the priority cache/storage may thus vary between type of data (as seen in the example of FIG. 3). In case of video or music chunk delivery, their delay on delivery is more sensitive than the delay on ordinary file delivery, and thus more chunks are to be kept in the priority cache. The number of prioritized chunks in the priority cache is a combination of data popularity and importance.

For scalability reasons storage management may be separated from the priority cache and that way it is able to manage several priority cache entities.

In an exemplary embodiment, the secondary cache(s) has at least one copy of each chunk of the content provisioned by the content delivery system. This means that an adequate number of dedicated (each time available) Torrent nodes are needed as part of the data storage system. In an exemplary embodiment, the data storage system may also be extended with existing Torrent systems, such as BitTorrent. Support for these non-dedicated data storage systems may require implementation/support of adequate tracker/client function(s) in the data storage management function. For example, when some content becomes popular and gets downloaded through BitTorrent, the clients downloading the content become temporary storages of that particular content for the data storage system in its non-dedicated BitTorrent system.

Thus, an exemplary embodiment involves benefits of peer-to-peer type solutions, and, contrary to the Spotify-type solutions, the complexity may be hidden from the user of the data storage/cache memory. In an exemplary embodiment, the user gets data delivered from the data storage/cache only, even if the data chunks are available from the secondary cache. This simplifies the interaction for data users (in Spotify style solutions, the client needs to participate in the peer-to-peer interaction, thus clearly adding complexity for the client).

An exemplary embodiment enables observing of data traffic demands. A majority of large data file downloads, such as video clips or movies, have a usage profile where the first data chunks are viewed, while the probability of viewing later chunks decreases. The reason being that the subject viewed is interesting in the beginning, but after a while, the willingness to view content until the end is decreasing. This means that for some use cases the most important chunks are the first ones of the file, while later chunks are with a lesser probability needed at the client.

The studies of cacheable content indicate that there is a large portion of data that is rarely used but still benefits from the caching. An exemplary embodiment enlarges the amount of data possible to be cached, and especially the large amount of data more rarely used has a good response time even though it has a low popularity. An exemplary embodiment thus enables a high data representation ratio compared to the cache memory size.

Exemplary embodiments of the present invention will now be de-scribed more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Like reference numerals refer to like elements throughout.

The present invention is applicable to any user terminal, network element, server, corresponding component, and/or to any communication system or any combination of different communication systems that support accessing data collections by means of functional programming. The communication system may be a fixed communication system or a wireless communication system or a communication system utilizing both fixed networks and wireless networks. The protocols used, the specifications of communication systems, servers and user terminals, especially in wireless communication, develop rapidly. Such development may require extra changes to an embodiment. Therefore, all words and expressions should be interpreted broadly and they are intended to illustrate, not to restrict, the embodiment.

In the following, different embodiments will be described using, as an example of a system architecture whereto the embodiments may be applied, without restricting the embodiment to such an architecture, however.

With reference to FIG. 4, let us examine an example of a radio system to which embodiments of the invention can be applied. In this example, the radio system is based on LTE network elements. However, the invention described in these examples is not limited to the LTE radio systems but can also be implemented in other radio systems, such as UMTS (universal mobile telecommunications system), GSM, EDGE, WCDMA, bluetooth network, WLAN or other fixed, mobile or wireless network. In an embodiment, the presented solution may be applied between elements belonging to different but compatible systems such as LTE and UMTS.

A general architecture of a communication system is illustrated in FIG. 4. FIG. 4 is a simplified system architecture only showing some elements and functional entities, all being logical units whose implementation may differ from what is shown. The connections shown in FIG. 4 are logical connections; the actual physical connections may be different. It is apparent to a person skilled in the art that the systems also comprise other functions and structures. It should be appreciated that the functions, structures, elements, and protocols used in or for fixed or wireless communication are irrelevant to the actual invention. Therefore, they need not be discussed in more detail here.

The exemplary radio system of FIG. 4 comprises a network apparatus 401 of a network operator. The network apparatus 401 may include e.g. a gateway GPRS support node (GGSN), MSC server (MSS), serving GPRS support node (SGSN), mobility management entity (MME), home location register (HLR), home subscriber server (HSS), visitor location register (VLR), or any other network element, or a combination of network elements. FIG. 4 shows the network node 401 operatively connected or integrated to a network element 402. The network element 402 may include a base station (node B, eNB), access point (AP), radio network controller (RNC), or any other network element or a combination of network elements. The network node 401 and the radio network node 402 are connected to each other via a connection 404 or via one or more further network elements. In FIG. 4, the radio network node 402 that may also be called eNB/RNC (enhanced node B/radio network controller) of the radio system hosts the functions for radio resource management in a public land mobile network. FIG. 4 shows one or more user equipment 403 located in the service area of the radio network node 402. The user equipment refers to a portable computing device, and it may also be referred to as a user terminal. Such computing devices include wireless mobile communication devices operating with or without a subscriber identification module (SIM) in hardware or in software, including, but not limited to, the following types of devices: mobile phone, smart-phone, personal digital assistant (PDA), handset, laptop computer. In the example situation of FIG. 4, the user equipment 403 is capable of connecting to the radio network node 402 via a connection 405.

FIG. 4 only illustrates a simplified example. In practice, the network may include more network elements and user terminals. The networks of two or more operators may overlap, the sizes and form of the cells may vary from what is depicted in FIG. 4, etc. The communication system may also be able to communicate with other networks, such as a public switched telephone network. The embodiments are not, however, restricted to the network given above as an example, but a person skilled in the art may apply the solution to other communication networks provided with the necessary properties. For example, the connections between different network elements may be realized with internet protocol (IP) connections.

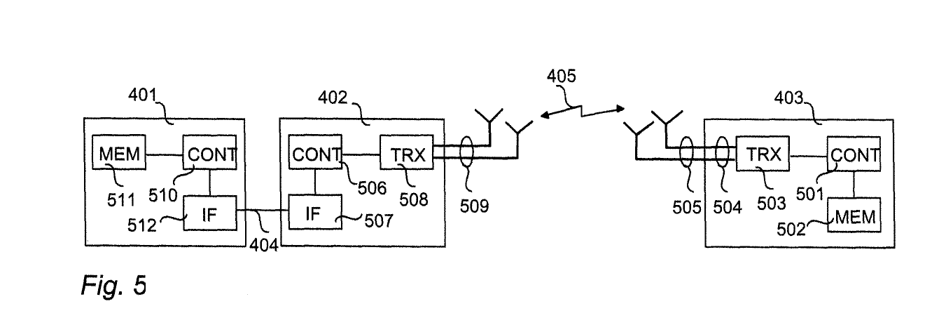

FIG. 5 illustrates examples of apparatuses according to embodiments of the invention. FIG. 5 shows a user equipment 403 located in the area of the radio network node or eNB/RNC 402. The user equipment is configured to be in connection with the radio network node 402. The user equipment or UE 403 comprises a controller 501 operationally connected to a memory 502 and a transceiver 503. The controller 501 controls the operation of the user equipment 403. The memory 502 is configured to store software and data. The transceiver 503 is configured to set up and maintain a wireless connection to the radio network node 402. The transceiver is operationally connected to a set of antenna ports 504 connected to an antenna arrangement 505. The antenna arrangement 505 may comprise a set of antennas. The number of antennas may be one to four, for example. The number of antennas is not limited to any particular number. The user equipment 403 may also comprise various other components, such as a user interface, camera, and media player. They are not displayed in the figure due to simplicity. The radio network node or eNB/RNC 402 comprises a controller 506 operationally connected to an interface 507 and a transceiver 508. The controller 506 controls the operation of the radio network node 402. The transceiver 508 is configured to set up and maintain a wireless connection to the user equipment 403 within the service area of the radio network node 402. The transceiver 508 is operationally connected to an antenna arrangement 509. The antenna arrangement may comprise a set of antennas. The number of antennas may be two to four, for example. The number of antennas is not limited to any particular number. The radio network node may be operationally connected (directly or indirectly) to another network element 401 of the communication system. The network element 401 may be a gateway GPRS support node, an operations, administrations and maintenance (OAM) node, a home location register (HLR), visitor location register (VLR), MSC server (MSS), a mobile switching centre (MSC), serving GPRS support node, MME (mobility management entity), a base station controller (BSC), a gateway, or a server, for example. The network node 402 may be connected to more than one network element. The network node 402 may comprise an interface 507 configured to set up and maintain connections with the network elements. The network element or NE 401 may comprise a controller 510 and a memory 511 configured to store software and data and an interface 512 configured to be in connection with the network node 402. The network element 401 may be operationally connected (directly or indirectly) to another network element of the communication system. The embodiments are not, however, restricted to the network given above as an example, but a person skilled in the art may apply the solution to other communication networks provided with the necessary properties. For example, the connections between different network elements may be realized with internet protocol (IP) connections.

The memory may include volatile and/or non-volatile memory and typically stores content, data, or the like. For example, the memory may store computer program code such as software applications (for example for the detector unit and/or for the adjuster unit) or operating systems, information, data, content, or the like for the processor to perform steps associated with operation of the apparatus in accordance with embodiments. The memory may be, for example, random access memory (RAM), a hard drive, or other fixed data memory or storage device. Further, the memory, or part of it, may be removable memory detachably connected to the apparatus.

The techniques described herein may be implemented by various means so that an apparatus implementing one or more functions of a corresponding mobile entity described with an embodiment comprises not only prior art means, but also means for implementing the one or more functions of a corresponding apparatus described with an embodiment and it may comprise separate means for each separate function, or means may be configured to perform two or more functions. For example, these techniques may be implemented in hardware (one or more apparatuses), firmware (one or more apparatuses), software (one or more modules), or combinations thereof. For a firm-ware or software, implementation can be through modules (e.g., procedures, functions, and so on) that perform the functions described herein. The software codes may be stored in any suitable, processor/computer-readable data storage medium(s) or memory unit(s) or article(s) of manufacture and executed by one or more processors/computers. The data storage medium or the memory unit may be implemented within the processor/computer or external to the processor/computer, in which case it can be communicatively coupled to the processor/computer via various means as is known in the art.

User equipment may refer to any user communication device. A term “user equipment” as used herein may refer to any device having a communication capability, such as a wireless mobile terminal, a PDA, tablet, a smart phone, a personal computer (PC), a laptop computer, a desktop computer, etc. For example, the wireless communication terminal may be an UMTS or GSM/EDGE smart mobile terminal having wireless modem. Thus, the application capabilities of the device according to various embodiments of the invention may include native applications available in the terminal, or subsequently installed applications by the user or operator or other entity. The gateway GPRS support node may be implemented in any network element, such as a server.

FIG. 5 is a block diagram of an apparatus according to an embodiment of the invention. Although the apparatus has been depicted as one entity, different modules and memory may be implemented in one or more physical or logical entities.

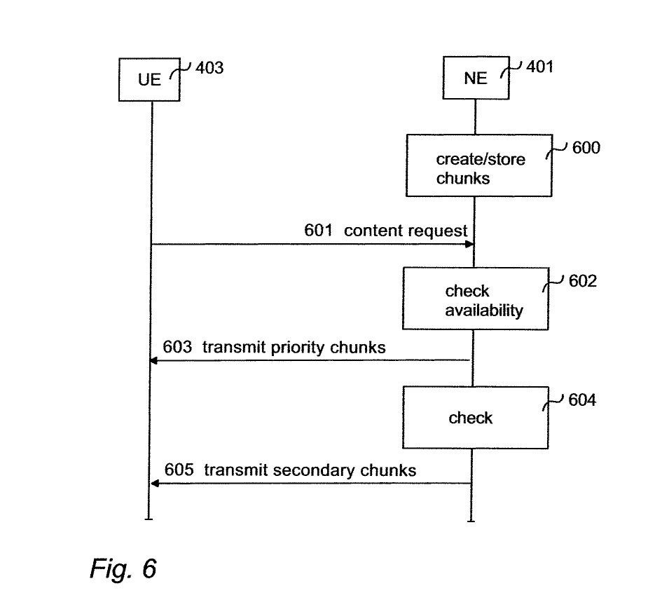

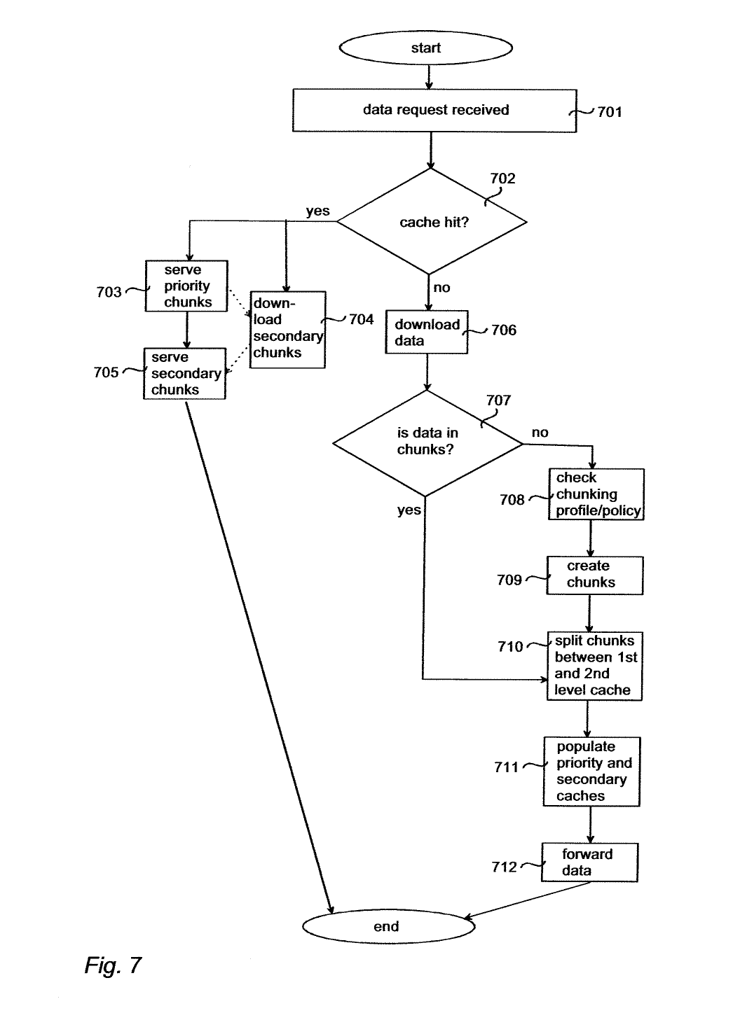

The functionality of the network apparatus 401, 403 is described in more detail below with FIGS. 6 and 7. It should be appreciated that the apparatus 401, 403 may comprise other units used in or for distributed computing and/or data federation. However, they are irrelevant to the actual invention and, therefore, they need not to be discussed in more detail here.

The apparatus may also be a user terminal which is a piece of equipment or a device that associates, or is arranged to associate, the user terminal and its user with a subscription and allows a user to interact with a communications system. The user terminal presents information to the user and allows the user to input information. In other words, the user terminal may be any terminal capable of receiving information from and/or transmitting information to the network, connectable to the network wirelessly or via a fixed connection. Examples of the user terminal include a personal computer, a game console, a laptop (a notebook), a personal digital assistant, a mobile station (mobile phone), and a line telephone.

The apparatus 401, 403 may generally include a processor, controller, control unit or the like connected to a memory and to various interfaces of the apparatus. Generally the processor is a central processing unit, but the processor may be an additional operation processor. The processor may comprise a computer processor, application-specific integrated circuit (ASIC), field-programmable gate array (FPGA), and/or other hardware components that have been programmed in such a way to carry out one or more functions of an embodiment.

The techniques described herein may be implemented by various means so that an apparatus implementing one or more functions of a corresponding mobile entity described with an embodiment comprises not only prior art means, but also means for implementing the one or more functions of a corresponding apparatus described with an embodiment and it may comprise separate means for each separate function, or means may be configured to perform two or more functions. For example, these techniques may be implemented in hardware (one or more apparatuses), firmware (one or more apparatuses), software (one or more modules), or combinations thereof. For a firm-ware or software, implementation may be through modules (e.g. procedures, functions, and so on) that perform the functions described herein. The software codes may be stored in any suitable, processor/computer-readable data storage medium(s) or memory unit(s) or article(s) of manufacture and executed by one or more processors/computers. The data storage medium or the memory unit may be implemented within the processor/computer or external to the processor/computer, in which case it may be communicatively coupled to the processor/computer via various means as is known in the art.

The signalling chart of FIG. 6 illustrates the required signalling. In the example of FIG. 6, a network apparatus 401 which may comprise e.g. a network element (network node), is able to download content from a data storage. A storage management function of the network element 401 enables chunking, in step 600, of the content such that prioritized chunks are kept available in a priority cache, and non-prioritized chunks (and also a copy of the prioritized chunks) are distributed temporarily into at least one secondary cache. Chunking of data refers to an action where data files and/or data stream is divided into smaller data units (i.e. “chunks”) and where the order of the data units are defined to make replication of the original data possible. The size of the chunks may be calculated according data usage criteria. There may be a few dependencies that impact the chunk size calculation: the secondary cache system may require a certain chunk size to operate efficiently, the combination of data access rate and application requirements such as video streaming needs a certain data size delivery, and/or the cache utilization performance in the cache management process likes to optimize suitable chunk size. The prioritized chunks may include e.g. one or more chunks that are needed in a fast enabling of the content service at the receiver end (for example, the first 30 seconds of a video). Non-prioritized chunks may refer e.g. to data that is to be sent to a further network apparatus 403 which may comprise e.g. a user equipment (user terminal), after the prioritized chunks (for example, in the video case, the remaining chunks in their consumption order).

The user terminal 403 may transmit (possibly via a further network node such as eNB/RNC 402, not shown in FIG. 6), to the network apparatus 401, a content request message 601, the request identifying the requested content service (such as a YouTube video clip). In step 602, the request 601 is received in the network element 401 (e.g. a gateway GPRS support node 401). Based on the received request 601, the network element 401 is configured to check, in step 602, whether the requested content or at least a part of it (i.e. prioritized chunk(s)) is available in the priority (level-1) cache (i.e. in the temporary master storage). Thus, in step 602, the apparatus 401 checks the location of the data chunks requested. If at least a part of the requested content is available in the priority cache of the network apparatus 401, the apparatus 401 is then immediately able to start transmitting 603 the content from the prioritized chunks (in parallel, the apparatus 401 starts to retrieve content chunks from the secondary cache to the priority cache for delivery). Thus the apparatus 401 is also configured to retrieve the non-prioritized chunks from the secondary cache to the priority storage. The secondary chunks are transmitted 605 to the user terminal 403 after the prioritized chunks. The apparatus may also be configured to check 604 whether or not the user of the user terminal 403 has interrupted the reception of the content wherein if the reception of the content has not been interrupted in the user equipment the apparatus is configured to transmit 605 the content corresponding to the secondary chunks to the user terminal 403. It should be noted that the apparatus 401 is able start the retrieval of the secondary chunks from the secondary cache in parallel with the downloading and/or transmitting of the prioritized chunks. A delivery of the secondary chunks from the priority cache to the user terminal is, however, started only if requests for the secondary chunks are presented. Thus, the content is partitioned into chunks, and the transmittal of each chunk to the user terminal requires that it has been requested by the user terminal. The transmittal is interrupted if no request for the subsequent chunk is received in the apparatus 401 while the latest bytes of the previous chunk are on their way to the user terminal 403. Thus e.g. a video needs not be transmitted as one huge chunk, but it may be partitioned into small, e.g. of a few seconds, parts. After the content request has been fully served and no pending request for the same content exists, the content may be kept in the priority cache for a short period of time (on hold for a possible new request). If no new request is received during that period, the non-prioritized content chunks may be removed from the priority cache (not shown in FIG. 6). The number of chunks to be held in the priority cache may also be varied based on the type/importance/popularity of data. Thus, the apparatus may be configured to define which chunks are to be kept in the priority cache depending on the type/importance/popularity/delivery order of data.

FIG. 7 is a flow chart illustrating an exemplary embodiment. The apparatus 401, which may comprise e.g. a network element (network node, e.g. a gateway GPRS support node 401), receives, in step 701, from a user equipment (user terminal), a content request message (transmitted possibly via a further network node such as eNB/RNC 402). The request identifies the requested content service (such as a YouTube video clip). The network element 401 checks, in step 702, whether chunks regarding the requested content are found in a cache. If prioritized chunks are found in a priority cache, the network element 401 starts transmitting 703 the prioritized chunks to the user terminal 403. In the meantime, the network element 401 starts downloading 704 secondary (low priority, non-prioritized) chunks from the secondary cache to the priority cache. After the prioritized chunks have been served to the user terminal 403, the network element 401 may start transmitting 705 the secondary chunks to the user terminal 403. If no cache is found in step 702, the network element 401 downloads 706 data from data storage of the original content publisher. In step 707, the network element 401 may check whether or not the data to be downloaded is in chunks. If the data is not in chunks, the network element 401 checks a chunking profile/chunking policy regarding the content in step 709, the network element 401 creates the chunks (i.e. divides the content into chunks) according to the chunking profile/policy. In step 710, the network element 401 defines which chunks are prioritized. If the data is already in chunks in step 707, the network element 401 may proceed directly to step 710 where the network element 401 defines which chunks are to be kept in the priority cache and which chunks are to be kept (temporarily) in the secondary cache. In step 711, the network element 401 stores each chunk to the secondary cache, and copies of the prioritized chunks also to the priority cache. In step 712, the network is able to start transmitting the data chunks to the user terminal 403.

The chunking policy/chunking profile may be content specific, operator specific, user terminal specific, publisher specific, and/or content provider specific. For example, according to a chunking profile, data from a certain content provider may be cached every time, or never be cached. In addition, these rules may include a combination of “black and white lists” where the former explicitly defines what is never cached and, respectively, the latter defines what is cached every time.

Thus, according to an exemplary embodiment, there is provided a method for intelligent data storage management using peer-to-peer mechanisms, by partitioning the data into chunks to be stored in at least one priority cache and in at least one secondary cache; wherein, in response to receiving, in a network apparatus, a content request message related to a user terminal, the method comprises checking whether at least a part of the requested content is available in the at least one priority cache; wherein, if at least a part of the requested content is available in the at least one priority cache, the method comprises transmitting one or more prioritized chunks of the content to the user terminal, the prioritized chunks being stored in the at least one priority cache; retrieving non-prioritized chunks of the content to the at least one priority cache from the at least one secondary cache; and transmitting one or more of the retrieved non-prioritized chunks of the content to the user terminal.

According to another exemplary embodiment, there is provided a method wherein, after the content request has been served and no pending request for the same content exists, the content is kept in the at least one priority cache for a predefined period of time, wherein if no further request is received during the predefined period, the method comprises removing the non-prioritized chunks from the at least one priority cache.

According to yet another exemplary embodiment, there is provided a method comprising defining, on the basis of one or more of a type, importance, delivery order and popularity of chunked content, which chunks are at least temporarily kept in the at least one priority cache.

According to yet another exemplary embodiment, there is provided a method comprising chunking the content such that each chunk is stored in the at least one secondary cache, wherein copies of the prioritized chunks are also stored in the at least one priority cache.

According to yet another exemplary embodiment, there is provided a method comprising downloading the data for partitioning and caching when a content request for the content is received for the first time.

According to yet another exemplary embodiment, the at least one priority cache enables a faster response to the content request message than the at least one secondary cache.

According to yet another exemplary embodiment, the at least one secondary cache is based on a peer-to-peer network architecture.

According to yet another exemplary embodiment, the prioritized chunks include one or more chunks that are needed in a fast enabling of the content service at the user terminal.

According to yet another exemplary embodiment, the non-prioritized chunks include data that is to be sent to the user terminal after the prioritized chunks.

According to yet another exemplary embodiment, there is provided a method comprising defining a chunking policy, the chunking policy being content specific, operator specific, user terminal specific, publisher specific, and/or content provider specific.

According to yet another exemplary embodiment, there is provided a method comprising calculating the size of the chunk according to data usage criteria.

According to yet another exemplary embodiment, the requested content comprises a data file, a video file and/or an audio file.

According to yet another exemplary embodiment, there is provided a method comprising checking whether or not the reception of the content has been interrupted in the user terminal; and transmitting one or more of the retrieved non-prioritized chunks of the content to the user terminal if the reception of the content has not been interrupted in the user equipment.

According to yet another exemplary embodiment, there is provided an apparatus configured to partition data into chunks to be stored in at least one priority cache and in at least one secondary cache; wherein, in response to receiving a content request message related to a user terminal, the apparatus is configured to check whether at least a part of the requested content is available in the at least one priority cache; wherein if at least a part of the requested content is available in the at least one priority cache, the apparatus is configured to transmit one or more prioritized chunks of the content to the user terminal, the prioritized chunks being stored in the at least one priority cache; retrieve non-prioritized chunks of the content to the at least one priority cache from the at least one secondary cache; and transmit one or more of the retrieved non-prioritized chunks of the content to the user terminal.

According to yet another exemplary embodiment, there is provided an apparatus configured to, after the content request has been served and no pending request for the same content exists, keep the content in the at least one priority cache for a predefined period of time, wherein if no further request is received during the predefined period, the apparatus is configured to remove the non-prioritized chunks from the at least one priority cache.

According to yet another exemplary embodiment, there is provided an apparatus configured to define, on the basis of one or more of a type, importance, delivery order and popularity of chunked content, which chunks are at least temporarily kept in the at least one priority cache.

According to yet another exemplary embodiment, there is provided an apparatus configured to chunk the content such that each chunk is stored in the at least one secondary cache, wherein copies of the prioritized chunks are also stored in the at least one priority cache.

According to yet another exemplary embodiment, there is provided an apparatus configured to download the data for partitioning and caching when a content request for the content is received in the apparatus for the first time.

According to yet another exemplary embodiment, there is provided an apparatus configured to interface a peer-to-peer type network architecture as the at least one secondary cache.

According to yet another exemplary embodiment, there is provided an apparatus configured to check whether or not the reception of the content has been interrupted in the user terminal; and transmit one or more of the retrieved non-prioritized chunks of the content to the user terminal if the reception of the content has not been interrupted in the user equipment.

According to yet another exemplary embodiment, there is provided an apparatus configured to define a chunking policy, the chunking policy being content specific, operator specific, user terminal specific, publisher specific, and/or content provider specific.

According to yet another exemplary embodiment, there is provided an apparatus configured to calculate the size of the chunk according to data usage criteria.

According to yet another exemplary embodiment, the apparatus comprises a gateway GPRS support node.

According to yet another exemplary embodiment, there is provided a computer-readable storage medium embodying a program of instructions executable by a processor to perform actions directed toward partitioning the data into chunks to be stored in at least one priority cache and in at least one secondary cache; checking, in response to receiving, in a network apparatus, a content request message related to a user terminal, whether at least a part of the requested content is available in the at least one priority cache; transmitting, if at least a part of the requested content is available in the at least one priority cache, one or more prioritized chunks of the content to the user terminal, the prioritized chunks being stored in the at least one priority cache; retrieving non-prioritized chunks of the content to the at least one priority cache from the at least one secondary cache; and transmitting one or more of the retrieved non-prioritized chunks of the content to the user terminal.

It will be obvious to a person skilled in the art that, as the technology advances, the inventive concept may be implemented in various ways. The invention and its embodiments are not limited to the examples described above but may vary within the scope of the claims.

### LIST OF ABBREVIATIONS

ICN information centric networking

GGSN gateway GPRS support node

GPRS general packet radio service

1.-27. (canceled)

28. A method of caching data in a communications system, the method comprising
partitioning the data into chunks to be stored in at least one priority cache and in at least one secondary cache;
wherein, in response to receiving, in a network apparatus a content request message related to a user terminal, the method comprises
checking whether at least a part of the requested content is available in the at least one priority cache;
wherein, if at least a part of the requested content is available in the at least one priority cache, the method comprises
transmitting one or more prioritized chunks of the content to the user terminal, the prioritized chunks being stored in the at least one priority cache;
retrieving non-prioritized chunks of the content to the at least one priority cache from the at least one secondary cache; and
transmitting one or more of the retrieved non-prioritized chunks of the content to the user terminal.

29. A method as claimed in claim 28, wherein after the content request has been served and no pending request for the same content exists, the content is kept in the at least one priority cache for a predefined period of time, wherein if no further request is received during the predefined period, the method comprises removing the non-prioritized chunks from the at least one priority cache.

30. A method as claimed in claim 28, characterized by defining, on the basis of one or more of a type, importance, delivery order and popularity of chunked content, which chunks are at least temporarily kept in the at least one priority cache.

31. A method as claimed in claim 28, characterized by chunking the content such that each chunk is stored in the at least one secondary cache, wherein copies of the prioritized chunks are also stored in the at least one priority cache.

32. A method as claimed in claim 28, characterized by downloading the data for partitioning and caching when a content request for the content is received for the first time.

33. A method as claimed in claim 28, wherein the at least one priority cache enables a faster response to the content request message than the at least one secondary cache.

34. A method as claimed in claim 28, wherein the prioritized chunks include one or more chunks that are needed in a fast enabling of the content service at the user terminal.

35. A method as claimed in claim 28, wherein the method comprises defining a chunking policy, the chunking policy being content specific, operator specific, user terminal specific, publisher specific, and/or content provider specific.

36. A method as claimed in claim 28, wherein the size of the chunk is calculated according to data usage criteria.

37. A method as claimed in claim 28, further comprising
checking whether or not the reception of the content has been interrupted in the user terminal; and
transmitting one or more of the retrieved non-prioritized chunks of the content to the user terminal if the reception of the content has not been interrupted in the user equipment.

38. An apparatus for communications, wherein the apparatus is configured to
partition data into chunks to be stored in at least one priority cache and in at least one secondary cache;
wherein, in response to receiving a content request message related to a user terminal, the apparatus is configured to
check whether at least a part of the requested content is available in the at least one priority cache;
wherein if at least a part of the requested content is available in the at least one priority cache, the apparatus is configured to
transmit one or more prioritized chunks of the content to the user terminal, the prioritized chunks being stored in the at least one priority cache;
retrieve non-prioritized chunks of the content to the at least one priority cache from the at least one secondary cache; and
transmit one or more of the retrieved non-prioritized chunks of the content to the user terminal.

39. An apparatus as claimed in claim 38, wherein after the content request has been served and no pending request for the same content exists, the apparatus is configured to
keep the content in the at least one priority cache for a predefined period of time, wherein if no further request is received during the predefined period, the apparatus is configured to
remove the non-prioritized chunks from the at least one priority cache.

40. An apparatus as claimed in claim 38, wherein the apparatus is configured to define, on the basis of one or more of a type, importance, delivery order and popularity of chunked content, which chunks are at least temporarily kept in the at least one priority cache.

41. An apparatus as claimed in claim 38, wherein the apparatus is configured to chunk the content such that each chunk is stored in the at least one secondary cache, wherein copies of the prioritized chunks are also stored in the at least one priority cache.

42. An apparatus as claimed in claim 38, wherein the apparatus is configured to download the data for partitioning and caching when a content request for the content is received in the apparatus for the first time.

43. An apparatus as claimed in claim 38, wherein the prioritized chunks include one or more chunks that are needed in a fast enabling of the content service at the user terminal.

44. An apparatus as claimed in claim 38, wherein it is configured to check whether or not the reception of the content has been interrupted in the user terminal; and
transmit one or more of the retrieved non-prioritized chunks of the content to the user terminal if the reception of the content has not been interrupted in the user equipment.

45. An apparatus as claimed in claim 38, wherein it is configured to define a chunking policy, wherein the chunking policy is content specific, operator specific, user terminal specific, publisher specific, and/or content provider specific.

46. An apparatus as claimed in claim 38, wherein it is configured to calculate the size of the chunk according to data usage criteria.

47. A computer-readable storage medium embodying a program of instructions executable by a processor to perform actions directed toward
partitioning the data into chunks to be stored in at least one priority cache and in at least one secondary cache;
checking, in response to receiving, in a network apparatus a content request message related to a user terminal, whether at least a part of the requested content is available in the at least one priority cache;
transmitting, if at least a part of the requested content is available in the at least one priority cache, one or more prioritized chunks of the content to the user terminal, the prioritized chunks being stored in the at least one priority cache;
retrieving non-prioritized chunks of the content to the at least one priority cache from the at least one secondary cache; and
transmitting one or more of the retrieved non-prioritized chunks of the content to the user terminal.
